(19) United States
(12) Patent Application Publication
(10) Pub. No.: US 2006/0028541 A1
(43) Pub. Date: Feb. 9, 2006

(54) Video signal processor

(75) Inventor: Toshiaki Haraguchi, Ko fu-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION and PIONEER MICRO TECHNOLOGY CORPORATION

(21) Appl. No.: 11/196,505

(22) Filed: Aug. 4, 2005

(30) Foreign Application Priority Data
Aug. 6, 2004 (JP) 2004-230066

(51) Int. Cl. H04N 5/14; H04N 5/21

(52) U.S. Cl. 348/27; 348/625

(57) ABSTRACT

A video signal processor which can reduce the noise of quantized video signal. A bit-added video signal is prepared by adding a bit string of m−n bits to the least significant bit side of the input video signal. A smoothed video signal is prepared by performing smoothing processing on this bit-added video signal. The difference between the bit-added video signal and the smoothed video signal is compared with a predetermined threshold value. Either the bit-added video signal or the smoothed video signal is selected according to the comparison result. The selected video signal is output as the bit-extended video signal.

### BACKGROUND OF THE INVENTION

1. Field of the Invention

The present invention relates to a video signal processor for extending the number of bits of quantized video signals.

2. Description of the Related Art

A video signal processor to increase the number of bits of video signals after quantization so as to decrease the quantization errors of the quantized video signals is known in the art. One example of such video signal processors is disclosed in Japanese Patent Kokai (Laid-Open Application) No. 8-237669. FIG. 1 of the accompanying drawings shows a configuration of the video signal processor 100 of Japanese Patent Kokai No.8-237669.

In FIG. 1, the 8-bit video signal S1 is an input to the video signal processor 100. The signal S1 is received at the terminal 101. In the video signal processor 100, the 10-bit conversion circuit 102 adds a 2-bit [00] bit string to the LSB (Least Significant Bit) side of the 8-bit video signal S1 to generate the 10-bit video signal S2. The low pass filter 103 supplies the video signal S3, acquired by performing filter processing on the video signal S2, to the LSB extractor 104 and the adder 105 of the control signal output unit 120. The adder 105 subtracts the video signal S3 from the 10-bit video signal S2, and supplies this difference signal S5 to the comparator 106. The comparator 106 determines whether the absolute value of this difference signal S5 is greater than a predetermined threshold value, and generates a control signal C1 according to this determination result. The threshold value is a carry value for the bit string to be added in the 10-bit conversion circuit 102, in other words, a value which is “1” greater than the maximum value that can be expressed by this bit string. For example, if the bit string to be added in the 10-bit conversion circuit 102 is 2 bits, then the threshold value is “4” because the maximum value “3”, which can be expressed by this bit string, plus “1” is “4”. The comparator 106 also determines whether the difference signal S5 is a positive value smaller than the threshold value, and generates a control signal C2 according to the determination result. If the control signal C2 indicates that the difference signal S5 is a positive value smaller than the threshold value, then the adder 107 supplies the signal (video signal S6), acquired by subtracting the threshold value from the video signal S2, to the adder 109. If the control signal C2 indicates that the difference signal S5 is not a positive value smaller than the predetermined threshold value, i.e., if the difference signal S5 is greater than the threshold value or is a negative value, then the adder 107 supplies the difference signal S5 to the adder 109 as is, as the video signal S6. The LSB extractor 104 extracts the least significant 2 bits from the 10-bit video signal S3, and supplies these to the switch 108 as the signal S4. The switch 108 turns ON only if the control signal C1, corresponding to the judgment result that the absolute value of the difference signal S5 is smaller than the threshold value, is given, and supplies the signal S4 to the adder 109. If the control signal C1, corresponding to the judgment result that the absolute value of the difference signal S5 is not smaller than the threshold value, is supplied, the switch 108 turns OFF. In other words, the signal with level “0” is supplied to the adder 109. The adder 109 adds the signal supplied from the switch 108 to the video signal S6 and outputs the resultant as the video signal S7. The video signal S7 is a quantization-error-reduced signal. The video signal S7 is output from the terminal 110 of the video signal processor 100.

In other words, in the video signal processor shown in FIG. 1, 2 bits of a bit string [00] are forcibly added to the LSB side of the 8-bit video signal S1 to generate a 10-bit video signal S2 first. Then from the video signal S3, acquired by smoothing the video signal S2 in the LPF 103, the least significant 2 bits are extracted by the LSB extractor 104, so as to generate the insignificant 2 bits (signal S4) to be extended. The value of these insignificant 2 bits for extension is added to the video signal S2 in the adder 109 to provide the 10-bit video signal S7. The video signal S7 is a signal which is extended to 10 bits from 8 bits.

In the video signal processing shown in FIG. 1, the video signal is smoothed by the low pass filter to generate the insignificant 2 bits of data for extension. However if filtering processing by a low pass filter is performed on the video signals, an unnecessary ringing is generated in the flat part around the edge where the signal level changes. Ringing higher than the threshold value of the comparator 106 is removed, but ringing lower than the threshold value is not removed but remains, and it becomes new noise and is superimposed on the video signals.

### SUMMARY OF THE INVENTION

One object of the present invention is to provide a video signal processor that can decrease the noise of quantized video signals.

According to one aspect of the present invention, there is provided an improved video signal processor for generating a bit-extended video signal of m bits from n bits of a quantized input video signal, where m is greater than n. The video signal processor includes a bit addition unit for generating a bit-added video signal by adding a bit string of (m−n) bits to the least significant bit side of the input video signal. The video signal processor also includes a filter for generating a smoothed video signal by performing smoothing processing on the bit-added video signal. The video signal processor also includes a comparator for comparing the difference value between the bit-added video signal and the smoothed video signal, with a predetermined threshold value. The video signal processor also includes a selector for selecting either the bit-added video signals or the smoothed video signals according to the comparison result of the comparator, and outputting the selected signal as the bit-extended video signal.

These and other objects, aspects and advantages of the present invention will become apparent to those skilled in the art from the following detailed description and appended claims, when read and understood in conjunction with the accompanying drawings.

### BRIEF DESCRIPTION OF THE DRAWINGS

FIG. 1 is a block diagram depicting the configuration of a conventional video signal processor;

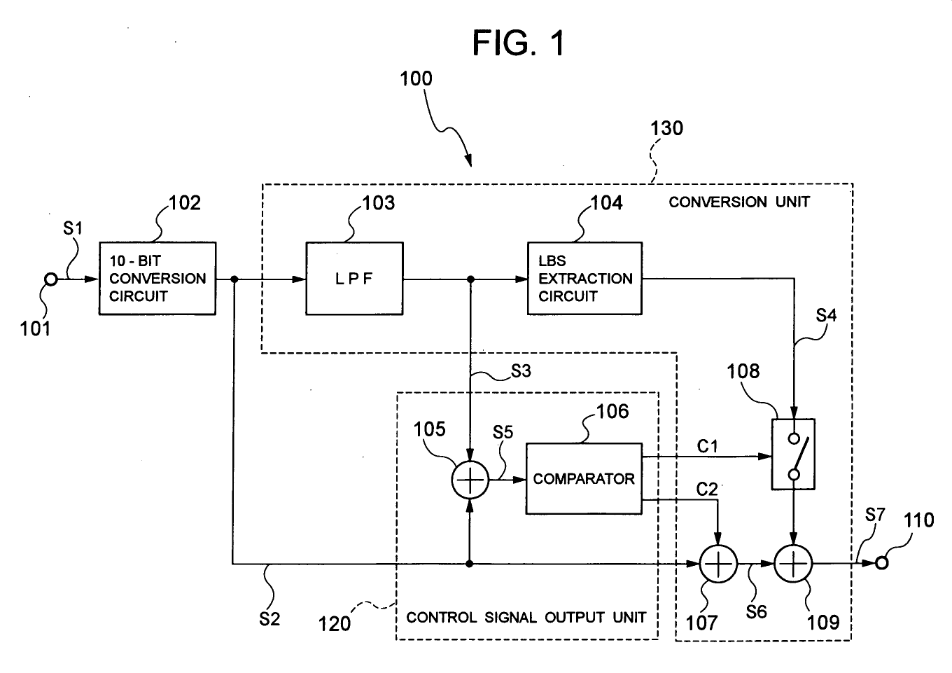

FIG. 2 is a block diagram of a video signal processor according to one embodiment of the present invention;

FIGS. 3A and 3B show two exemplary sets of coefficients used for detecting an edge from a video signal according to a two-dimensional operator method;

FIG. 4 is a block diagram of a filter used in the video signal processor shown in FIG. 2;

FIG. 5 is a diagram depicting pixel positions in a display screen of pixel data stored in a frame memory of the video signal processor shown in FIG. 2;

FIGS. 6A, 6B and 6C are a set of diagrams depicting a series of operations performed by the filter when an edge exists in the video signal;

FIGS. 7A and 7B illustrate smoothing of the video signal by filtering processing of the filter; and

FIGS. 8A, 8B and 8C illustrate an operation of the selector.

### DETAILED DESCRIPTION OF THE INVENTION

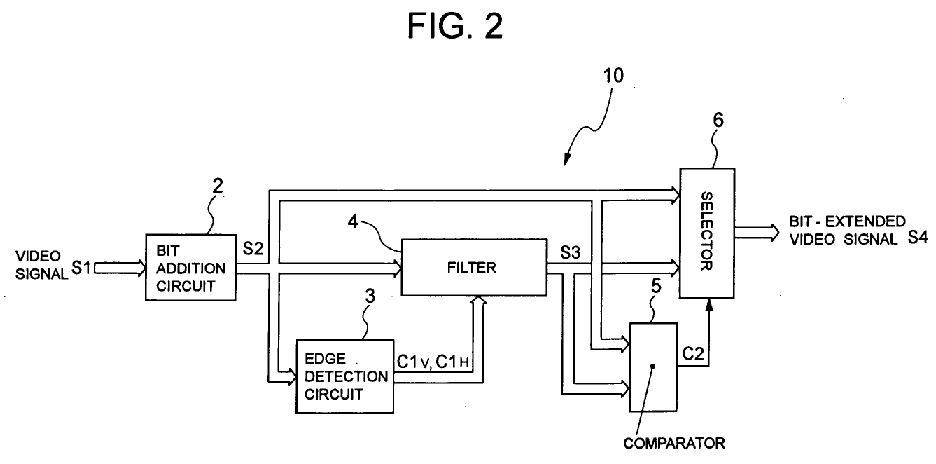

Referring to FIG. 2, a configuration of the video signal processor 10 according to one embodiment of the present invention will be described.

In FIG. 2, the input video signal S1 is a string of image data, which indicates the brightness levels of pixels of the display device (not illustrated) by n bits respectively. The bit addition circuit 2 receives the input video signal S1 and generates the bit-added video signal S2. The number of bits of each pixel data of the input video signal S1 is extended to m bits (n<m) by the bit addition circuit 2. In other words, the bit addition circuit 2 extends the number of bits of each pixel data from n bits to m bits by adding m−n bits of a bit string with logic level 0 at the least significant bit side of each pixel data in the input video signal S1. The bit addition circuit 2 supplies the bit-added video signal S2 to the edge detection circuit 3, filter 4, comparator 5 and selector 6 respectively.

The edge detection circuit 3 detects an edge, which is the area where the brightness level changes in the horizontal direction of the display screen, based on the bit-added video signal S2, and supplies the horizontal edge position signal C1_{H} to the filter 4. The horizontal edge position signal C1_{H} indicates the pixel positions of the edge. The edge detection circuit 3 detects another edge where the brightness level changes in the vertical direction of the display screen based on the bit-added video signal S2, and supplies the vertical edge position signal C1v to indicate the pixel positions of this edge to the filter 4. The edge detection circuit 3 performs the edge detection according to the two-dimensional differential operator method. The two-dimensional differential operator method is described below.

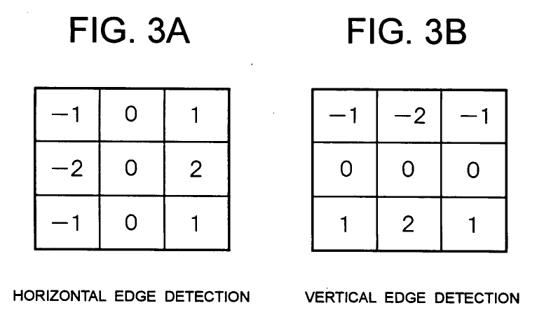

First the edge detection circuit 3 multiplies the m bits of pixel data, corresponding to the 9 pixels which are next to each other in the horizontal and vertical directions of the display screen, by the assigned coefficients shown in FIG. 3A, and determines (calculates) the total value of the multiplication results as the horizontal edge judgment result Gh. Then the edge detection circuit 3 determines whether the horizontal edge judgment value Gh is greater than a predetermined edge judgment threshold value. If the value Gh is determined to be greater than the threshold value, the edge detection circuit 3 determines the pixel data corresponding to the center pixel of the 9 pixels as the edge, and supplies the horizontal edge position signal C1H to indicate the pixel position to the filter 4. The edge detection circuit 3 also multiplies the m bits of the pixel data corresponding to the 9 pixels next to each other in the horizontal and vertical directions of the display screen by the coefficients assigned as shown in FIG. 3B, and calculates the total value of the multiplication results as the vertical edge judgment value Gv. Then the edge detection circuit 3 determines whether the vertical edge judgment value Gv is greater than a predetermined edge judgment threshold value. If the value Gv is determined to be greater than the threshold value, the edge detection circuit 3 takes the pixel data corresponding to the center pixel of the 9 pixels as the edge, and supplies the vertical edge position signal C1v to indicate the pixel position to the filter 4. As the edge judgment threshold value, a value (decimal notation) corresponding to the least significant bit digit in the n bits of the input video signal S1, for example, is used. In other words, if the level change of the video signal between the adjacent pixels is smaller than the value corresponding to the least significant bit digit, the edge detection circuit 3 determines that this as a flat area or a pseudo-contour area of the image, and if greater, the edge detection circuit 3 determines this as an edge.

The filter 4 includes the two-dimensional low pass filter such as an FIR (Finite Impulse Response) filter or an IIR (Infinite Impulse Response) filter.

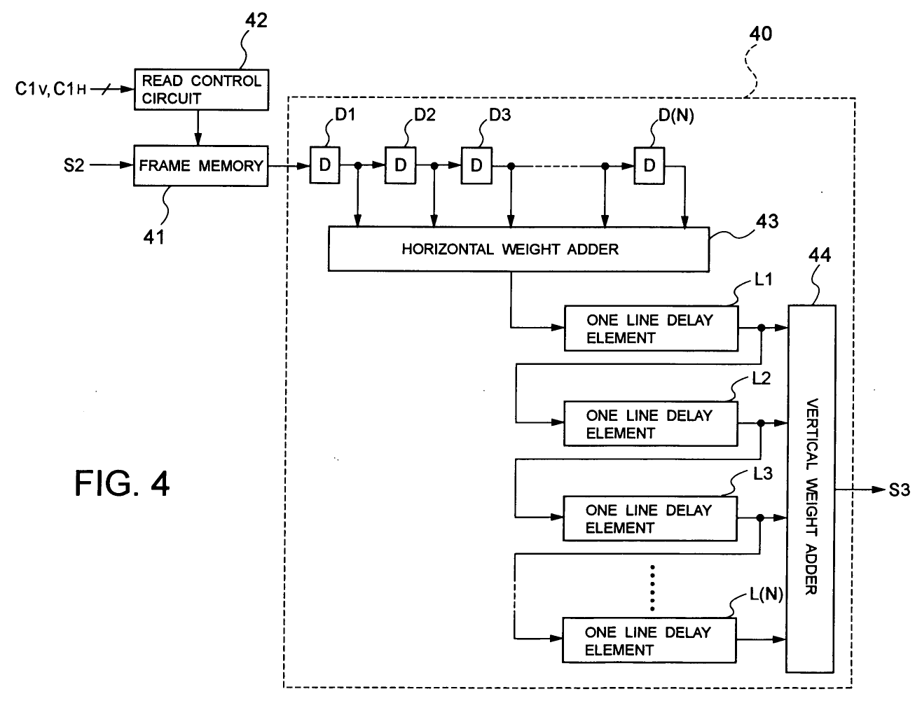

FIG. 4 depicts an example of the internal configuration of this filter 4.

As FIG. 4 shows, the filter 4 includes the two-dimensional low pass filter 40, frame memory 41 and read control circuit 42.

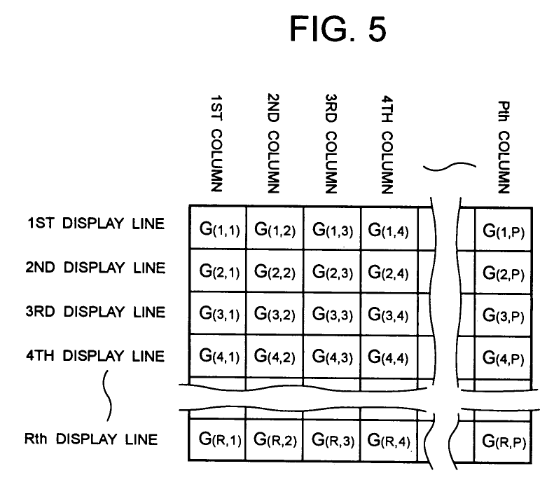

The frame memory 41 sequentially stores the pixel data of the bit-added video signal S2 at the addresses corresponding to the pixel positions of the pixels G_{(1, 1)}-G_{(R, P)} of the display screen shown in FIG. 5. The read control circuit 42 supplies the read signal, for reading the pixel data stored in the frame memory 41 at each N pixels which are next to each other in the horizontal direction of the display screen, to the frame memory 41. In other words, the read control circuit 42 supplies the read signal, for sequentially reading N pixel data corresponding to the pixels G_{(1, 1)}-G_{(1, N)} in the first to Nth columns of the first display line shown in FIG. 5, to the frame memory 41. Then the read control circuit 42 supplies the read signal, for sequentially reading N pixel data corresponding to the pixels G_{(1, 2)}-G_{(1, N+1)} of the second to (N+1)th columns of the first display line, to the frame memory 41. Then the read control circuit 42 supplies the read signal, for sequentially reading N pixel data corresponding to the pixels G_{(1, 3)}-G_{(1, N+2)} of the third to (N+2)th columns of the first display line, to the frame memory 41. Hereafter in the same manner, the read control circuit 42 supplies the read signal, for reading N pixel data corresponding to N pixels of the first display line, to the frame memory 41, N pixels at a time. When reading the pixel data corresponding to each pixel of the first display line ends, the read control circuit 42 supplies the read signal, for sequentially reading N pixel data corresponding to the pixels G_{(2, 1)}-G_{(2, N)} of the first column to Nth column of the second display line, to the frame memory 41. Then the read control circuit 42 supplies the read signal, for sequentially reading N pixel data corresponding to the pixels G_{(2, 2)}-G_{(2, N+1)} of the second column to the (N+1)th column of the second display line, to the frame memory 41. Then the read control circuit 42 supplies the read signal, for sequentially reading N pixel data corresponding to the pixels G_{(2, 3)}-G_{(2, N+2)} to the third column to the (N+2)th column of the second display line, to the frame memory 41. Hereafter in the same manner, the read control circuit 42 supplies the read signal, for reading the pixel data corresponding to N pixels of the second display line, to the frame memory 41, N pixels at a time. After reading the pixel data corresponding to each pixel of the second display line, the read control circuit 42 repeatedly supplies the read signal, for reading the N pixel data corresponding to N pixels of the third display line to the Rth display line shown in FIG. 5, to the frame memory 41, N pixels at a time, in the same manner.

When the pixel data are read from the frame memory 41, N pixels at a time, the read control circuit 42 determines whether the pixel data corresponding to the edge exists in the string of N continuous pixel data which are next to each other in the horizontal direction based on the horizontal edge position signal C1_{H}. Also the read control circuit 42 determines whether the pixel data corresponding to the edge exists in the string of N pixel data which are next to each other in the vertical direction based on the vertical edge position signal C1_{V}. If the pixel data corresponding to the edge does not exist, the read control circuit 42 executes read control so that the pixel data stored in the frame memory 41 is sequentially read for each pixel, as mentioned above. If the pixel data corresponding to the edge exists in the pixel data string, on the other hand, the read control circuit 42 executes read control for reading the pixel data immediately before the edge, when viewed from the filter center, instead of reading the pixel data corresponding to the pixels of this edge and after the edge.

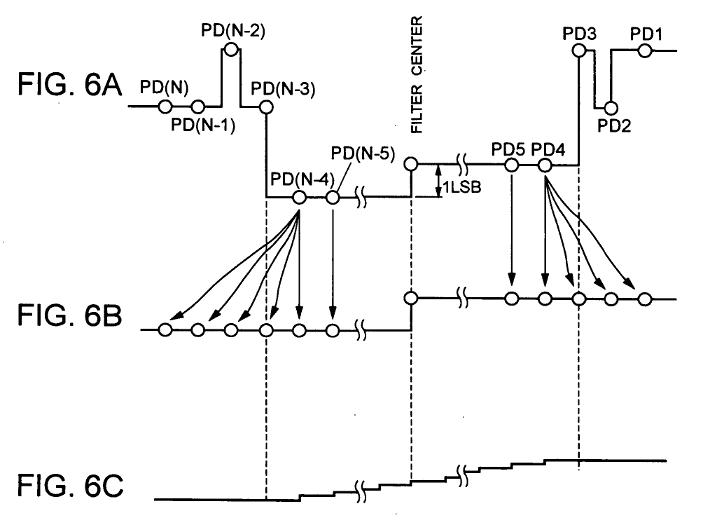

For example, if the pixel data PD3 corresponding to the edge exists in the first half of the N-pixel-data string shown in FIG. 6A, control to repeatedly read the pixel data PD4 instead of the pixel data PD1-PD3 is performed. The pixel data PD4 is the pixel data immediately before the pixel data PD3 on the edge, when viewed from the filter center. The pixel data PD1-PD3 are pixel data on and after the edge when viewed from the filter center. The_filter center is a center of two-dimensional image processing. It can be said that the pixel data PD4 is an inside pixel data with respect to the edge pixel data PD3, and the pixel data PD1 and PD2 are outside pixel data. If the pixel data PD(N−3) corresponding to the edge exists in the latter half of the N-pixel-data string shown in FIG. 6A, control to repeatedly read the pixel data PD(N−4) instead of the pixel data PD(N−3)-PD(N) is performed. The pixel data PD(N−4) is the pixel data immediately before the edge pixel-data PD(N−3), when viewed from the filter center. The pixel data PD(N−3)-PD(N) are pixel data on and after the edge. It can be said that the pixel data PD(N−4) is an inside pixel data with respect to the edge pixel data PD(N−3), and the pixel data PD(N−2) and PD(N−1) are outside pixel data.

Based on the read control by the read control circuit 42, the frame memory 41 sequentially reads the pixel data which does not correspond to the edge for each pixel, and supplies it to the two-dimensional low pass filter 40. During this time, for the pixel data on and after (or outside) the edge, the frame memory 41 reads the pixel data immediately before (or inside) the edge. If the pixel data string corresponding to the N pixels which are next to each other in the horizontal (or vertical) direction is as shown in FIG. 6A, for example, the value of the pixel data PD4 immediately before (or inside) the pixel data PD3 is repeatedly read, instead of the edge pixel data PD3 and the outside pixel data PD1 and PD2 in the first half thereof, as shown in FIG. 6B. Also the value of the pixel data PD(N−4) immediately before the pixel data PD(N−3) is repeatedly read and supplied to the two-dimensional low pass filter 40, as shown in FIG. 6B, instead of the edge pixel data PD(N−3) and the outside pixel data PD(N−2) and PD(N−1) in the latter half.

The two-dimensional low pass filter 40 includes a horizontal low pass filter. The horizontal low pass filter has N stages of unit delay elements D1-D(N) which are connected in series and the horizontal weight addition circuit 43. The two-dimensional low pass filter 40 also includes a vertical low pass filter. The vertical low pass filter has N stages of one line delay elements L1-L(N) which are connected in series and the vertical weight addition circuit 44.

Each of the unit delay elements D1-D(N) delays the pixel data of each pixel supplied from the frame memory 41 for a predetermined time, and supplies the delayed pixel data to the unit delay element D in the next stage. Therefore, each of the N pixel data read from the frame memory 41 is held by each of the unit delay elements D1-D(N) after a predetermined time×N (multiplied by N) elapses. When the predetermined time×N elapses and the N pixel data are held by the unit delay elements D1-D(N), then the horizontal weight addition circuit 43 adds the respective weights to the output values of the unit delay elements D1-D(N) and calculates the sum of these weighted values. In the horizontal weight addition circuit 43, the weight added to the output value of the unit delay element D(N/2), that is the weight for the center tap, is the largest weight, and the weight becomes smaller as the tap position becomes further away from the center tap. The horizontal weight addition circuit 43 supplies the weight addition result to the one line delay element L1. Each of the one line delay elements L1-L(N) delays the addition result supplied from the horizontal weight addition circuit 43 for the time of “the number of pixels of one horizontal scanning line×the predetermined time”, and outputs it to the one line delay element L in the next stage. The vertical weight addition circuit 44 adds the weights to the output values of the one line delay elements L1-L(N) and calculates the sum of the weighted values. The vertical weight addition circuit 44 supplies the sum as the smoothed video signal S3. In the vertical weight addition circuit 44, the weight added to the output value of the one line delay element L (N/2), that is the weight for the center tap, is largest, and the weight becomes smaller as the tap position becomes further away from the center tap.

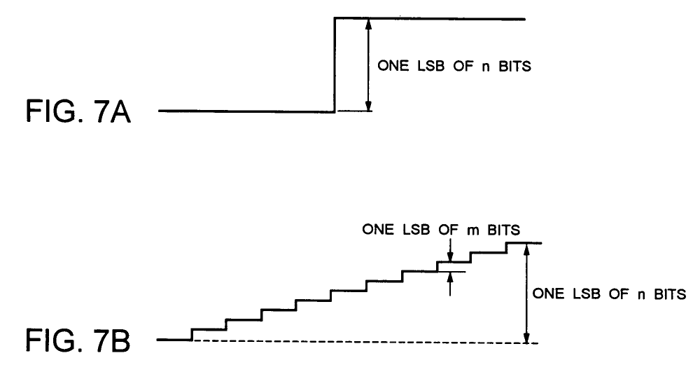

According to the above described configuration, the bit-added video signal S2 is m bits of an image data string, and the filter 4 generates m bits of the smoothed video signal S3 by smoothing the bit-added video signal S2 for each of the two-dimensional directions (vertical direction and horizontal direction) of the display screen. Based on this two-dimensional filtering processing, the smoothed video signal S3 is generated by smoothing the one LSB worth of the level change in the n bits of input video signal S1, shown in FIG. 7A, to 2^{(m-n)} stages of the level change, as shown in FIG. 7B. In other words, video signals which are more refined and which have reduced quantization noise and reduced pseudo-contour noise, compared to the original n bits of video signals, are generated.

In the filter 4, each pixel data (bit-added video signal S2) of the edge and the outside area of the edge where the brightness level changes in the video signal is replaced with the pixel data immediately inside the edge, that is the adjacent pixel data closer to the center tap of the filter, and filtering processing is performed on this pixel data. Because of this, even when the video signal including the ringing shown in FIG. 6A is introduced to the filter 4, filtering processing can be performed on the ringing-removed video signal as shown in FIG. 6B. The video signal S3 obtained by such filtering processing has a smoothed shape as shown in FIG. 6C, and the pseudo-contour noise is not outstanding.

The comparator 5 determines whether the difference between the value of each pixel data in the bit-added video signals S2 and the value of each pixel data in the smoothed video signal S3 is smaller than the predetermined threshold value Th. If the difference is smaller than the threshold value Th, the comparator 5 supplies the select signal C2 for selecting the smoothed video signal S3 to the selector 6. If the difference is the threshold value Th or more, then the comparator 5 supplies the select signal C2 for selecting the bit-added video signal S2 to the selector 6.

The selector 6 selects either the bit-added video signal S2 or the smoothed video signal S3, indicated by the select signal C2, and outputs the selected signal as the bit-extended video signal S4. The signal S4 has reduced quantization errors.

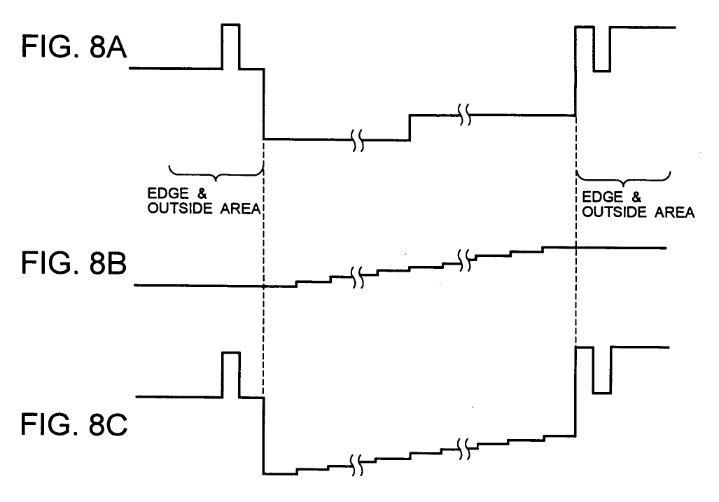

In other words, if the difference between the value of the image data in the smoothed video signal S3 and the value of the pixel data in the bit-added video signal S2 is smaller than the threshold value Th, then the selector 6 outputs the smoothed video signal S3 as the bit-extended video signal S4, and if the difference is the threshold value Th or more, the selector 6 outputs the bit-added video signal S2 as the bit-extended video signal S4. For the edge and its outside area in the bit-added video signal S2 shown in FIG. 8A, the selector 6 outputs the video signal S2 itself as the bit-extended video signal S4, as shown in FIG. 8C, and for the other area (inside area of the edge), the selector 6 outputs the smoothed video signal S3, shown in FIG. 8B which is obtained by smoothing the bit-added video signal S2, as the bit-extended signal S4.

Therefore for the edge which contributes greatly to improving resolution, dullness can be suppressed, and for the block of video signals where the change of the brightness level is small, such as the pseudo-contour area, the video signal can be smoothed and the pseudo-contour noise can be decreased.

This application is based on a Japanese Patent Application No.2004-230066 filed on Aug. 6, 2004, and the entire disclosure thereof is incorporated herein by reference.

What is claimed is:

1. A video signal processor for generating a bit-extended video signal of m bits from n bits of a quantized input video signal, where m is greater than n, said video signal processor comprising:
a bit adder for generating a bit-added video signal by adding a bit string of m−n bits to a least significant bit side of said input video signal;
a filter for generating a smoothed video signal by performing smoothing processing on said bit-added video signal;
a comparator for comparing a difference value between said bit-added video signal and said smoothed video signal, with a predetermined threshold value; and
a selector for selecting either said bit-added video signal or said smoothed video signal according to a comparison result by said comparator and outputting a selected video signal as said bit-extended video signal.

2. The video signal processor according to claim 1, further comprising an edge detector for detecting an edge in which a brightness level changes in said bit-added video signal, wherein said filter performs said smoothing processing after replacing values on and outside said edge in said bit-added video signal with a value immediately inside said edge, the outside and inside being defined from a center of the filter.

3. The video signal processor according to claim 1, wherein said selector selects and outputs said bit-added video signal as said bit-extended video signal if said difference value is greater than said predetermined threshold value, and selects and outputs said smoothed video signal as said bit-extended video signal if said difference value is equal to or smaller than said predetermined threshold value.

4. The video signal processor according to claim 1, wherein all the bits in said bit string have logical level 0.

5. The video signal processor according to claim 2, wherein the edge detector uses a two-dimensional differential operator method to detect the edge.

6. The video signal processor according to claim 1, wherein the filter includes a two-dimensional low pass filter.

7. The video signal processor according to claim 6, wherein the two-dimensional low pass filter includes an finite impulse response filter or an infinite impulse response filter.

8. A method of generating a bit-extended video signal of m bits from n bits of a quantized input video signal, where m is greater than n, said method comprising:
generating a bit-added video signal by adding a bit string of m−n bits to a least significant bit side of said input video signal;
generating a smoothed video signal by performing smoothing processing on said bit-added video signal;
comparing a difference value between said bit-added video signal and said smoothed video signal, with a predetermined threshold value; and
selecting either said bit-added video signal or said smoothed video signal according to a comparison result and outputting a selected video signal as said bit-extended video signal.

9. The method according to claim 8, further comprising detecting an edge in which a brightness level changes in said bit-added video signal, wherein said smoothing processing is performed after replacing values on and outside said edge in said bit-added video signal with a value immediately inside said edge, the outside and inside being defined from a center of the filter.

10. The method to claim 8, wherein said bit-added video signal is selected as said bit-extended video signal if said difference value is greater than said predetermined threshold value, and said smoothed video signal is selected as said bit-extended video signal if said difference value is equal to or smaller than said predetermined threshold value.

11. The method according to claim 8, wherein all the bits in said bit string have logical level 0.

12. The method according to claim 9, wherein said edge is detected by means of a two-dimensional differential operator method.

13. The method according to claim 8, wherein said smoothing is performed with a filter including a two-dimensional low pass filter.

14. An apparatus for generating a bit-extended video signal of m bits from n bits of a quantized input video signal, where m is greater than n, said apparatus comprising:
first means for generating a bit-added video signal by adding a bit string of m−n bits to a least significant bit side of said input video signal;
second means for generating a smoothed video signal by performing smoothing processing on said bit-added video signal;
third means for comparing a difference value between said bit-added video signal and said smoothed video signal, with a predetermined threshold value; and
fourth means for selecting either said bit-added video signal or said smoothed video signal according to a comparison result by said third means and outputting a selected video signal as said bit-extended video signal.

15. The apparatus according to claim 14, further comprising fifth means for detecting an edge in which a brightness level changes in said bit-added video signal, wherein said second means performs said smoothing processing after replacing values on and outside said edge in said bit-added video signal with a value immediately inside said edge, the outside and inside being defined from a center of the filter.

16. The apparatus according to claim 14, wherein said fourth means selects and outputs said bit-added video signal as said bit-extended video signal if said difference value is greater than said predetermined threshold value, and selects and outputs said smoothed video signal as said bit-extended video signal if said difference value is equal to or smaller than said predetermined threshold value.

17. The apparatus according to claim 14, wherein all the bits in said bit string have logical level 0.

18. The apparatus according to claim 15, wherein the fifth means uses a two-dimensional differential operator method to detect the edge.

19. The apparatus according to claim 14, wherein the second means includes a two-dimensional low pass filter.

20. The apparatus according to claim 19, wherein the two-dimensional low pass filter includes an finite impulse response filter or an infinite impulse response filter.
